(19) United States
(12) Patent Application Publication
(10) Pub. No.: US 2005/0069243 A1
(43) Pub. Date: Mar. 31, 2005

(54) Fiber-optic sensor probe for sensing and imaging

(76) Inventor: Ljerka Ukrainczyk, Painted Post, NY (US)

Correspondence Address: CORNING INCORPORATED, SP-TI-3-1, CORNING, NY, 14831, US

(21) Appl. No.: 10/954,701

(22) Filed: Sep. 29, 2004

Related U.S. Application Data
(60) Provisional application No. 60/507,626, filed on Sep. 30, 2003.

(51) Int. Cl. G02B 6/26; G02B 6/32

(52) U.S. Cl. 385/12; 385/33

(57) ABSTRACT

A method of making a fiber-optic sensor probe includes stripping a region of a buffered fiber to expose an underlying optical fiber and separating the optical fiber to form two fiber-optic sensor probes by simultaneously applying heat and axial tension to the optical fiber.

### BACKGROUND OF INVENTION

The invention relates to a fiber-optic sensor probe for sensing and imaging and a method of making the same.

Fiber-optic sensors generally include one or more optical fibers for transmitting light to and receiving light from an environment of interest, a light source for generating the light transmitted to the environment, and a light detector for detecting and analyzing the light received from the environment. Fiber-optic sensors can be used for sensing and detection of stimuli in a wide variety of applications, e.g., chemical applications such as in-situ reactor monitoring of chemical reactions, acidity measurements, and gas analysis (especially for explosive or flammable gases), and physical applications such as temperature, pressure, voltage and current monitoring, particle measurement, and motion monitoring. Fiber-optic sensors can also be used for imaging. Fiber-optic sensors offer the advantages of immunity to hostile environments, wide bandwidth, compactness, and high sensitivity as compared with other types of sensors.

Existing fiber-optic sensor probes are based on optical fibers that are modified in some way. FIG. 1A shows a sensing material 100 applied to the tip 102 of an optical fiber 104 to allow for monitoring of an environment by changes in optical properties of the sensing material. This approach offers limited sensitivity because the area for interaction with the environment is limited to the small area at the tip of the optical fiber. FIGS. 1B and 1C show cladding removed from a region 106 of an optical fiber 108 to allow for monitoring of an environment by changes in total internal reflection in the unclad region. This approach can offer a larger area for interaction with the environment but lacks robustness and sensitivity because detection is done via evanescent wave only. Lateral deformations called micro bends can also be made in optical fibers to allow for monitoring of an environment by changes in intensity of light radiating from the micro bends. However, these micro bends can be costly to manufacture.

From the foregoing, there is desired a fiber-optic sensor probe that has enhanced sensitivity, is robust, and is relatively inexpensive to manufacture.

### SUMMARY OF INVENTION

In one aspect, the invention relates to a method of making a fiber-optic sensor probe which comprises stripping a region of a buffered fiber thereby exposing an underlying optical fiber and separating the optical fiber to thus form two fiber-optic sensor probes by simultaneously applying heat and axial tension to the optical fiber.

In another aspect, the invention relates to a fiber-optic sensor probe which comprises an optical fiber having a distal end formed into a lens, the lens having a radius of curvature in a range from 5 to 30 μm.

In yet another aspect, the invention relates to a method of making a fiber-optic sensor probe which comprises stripping a region of a buffered fiber to expose an underlying optical fiber, separating the optical fiber to form two fiber-optic sensor probes by simultaneously applying heat and axial tension to the optical fiber, and applying heat to a distal end of at least one of the fiber-optic sensor probes such that surface tension pulls the distal end into a sphere.

In another aspect, the invention relates to a fiber-optic sensor probe which comprises an optical fiber having a distal end formed into a lens, the lens having a radius of curvature in a range from 30 to 500 μm.

Other features and advantages of the invention will be apparent from the following description and the appended claims.

### BRIEF DESCRIPTION OF DRAWINGS

FIG. 1A shows a prior-art fiber-optic sensor probe having an optical fiber and a sensing material applied to the tip of the optical fiber.

FIG. 1B shows a prior-art fiber-optic sensor probe having an optical fiber and an unclad region created at a distal end of the optical fiber.

FIG. 1C shows a prior-art fiber-optic sensor probe having an optical fiber and an unclad region created in the middle of the optical fiber.

FIG. 2A shows a fiber-optic sensor probe having a high numerical aperture according to one embodiment of the invention.

FIG. 2B shows the fiber-optic sensor probe of FIG. 2A in reflection mode.

FIG. 2C shows the fiber-optic sensor probe of FIG. 2A in transmission mode.

FIGS. 3A through 3C illustrate a method of forming a high numerical aperture fiber-optic sensor probe.

FIG. 4A shows a fiber-optic sensor probe having a low numerical aperture according to another embodiment of the invention.

FIG. 4B shows the fiber-optic sensor probe of FIG. 4A in reflection mode.

FIG. 4C shows the fiber-optic sensor probe of FIG. 4A in transmission mode.

FIG. 4D shows the lensed end of the fiber-optic sensor probe of FIG. 4A embedded in a sensing material.

FIG. 5 shows a ray trace of a low numerical aperture fiber-optic sensor probe.

FIG. 6A shows heat being applied to the taper-cut ends of optical fibers to form high numerical aperture fiber-optic sensor probes.

FIG. 6B shows two high numerical fiber-optic sensor probes formed from the method illustrated in FIG. 6A.

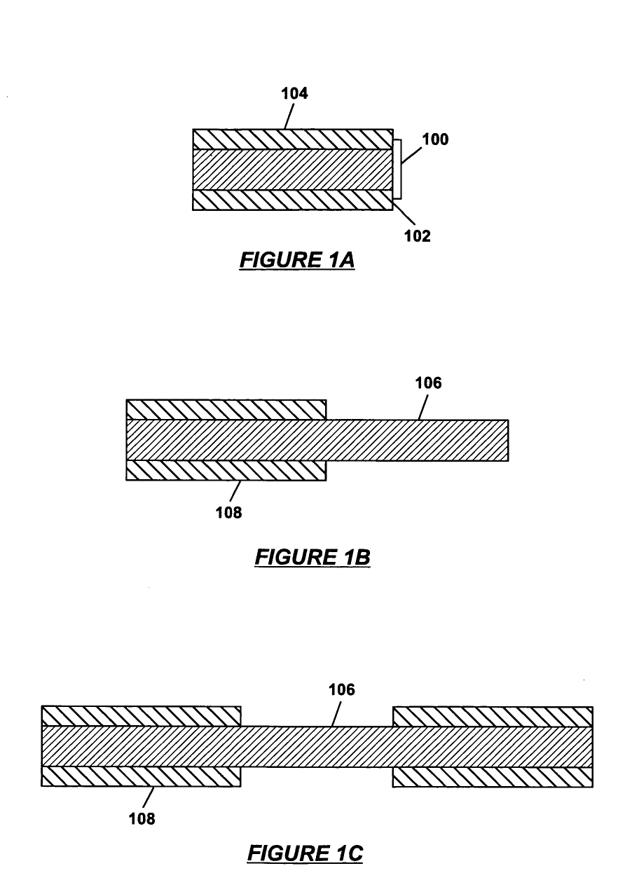

### DETAILED DESCRIPTION OF PREFERRED EMBODIMENTS

The invention will now be described in detail with reference to a few preferred embodiments, as illustrated in accompanying drawings. In the following description, numerous specific details are set forth in order to provide a thorough understanding of the invention. It will be apparent, however, to one skilled in the art, that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

A fiber-optic sensor probe consistent with the principles of the invention includes a lens formed at a distal end of an optical fiber. For a fiber-optic sensor probe having a low numerical aperture, the lens has a large radius of curvature, e.g., in a range from 30 to 500 μm. For sensing applications, this large-radius lens provides a high surface area for interaction with an environment of interest, improving the sensitivity of the fiber-optic sensor probe as compared with traditional fiber-optic sensor probes. For imaging applications, the large-radius lens decreases the numerical aperture of the optical fiber, providing a wide field of view and a long working distance. For a fiber-optic sensor probe having a high numerical aperture, the lens has a lens with a small radius of curvature, e.g., in a range from 5 to 30 μm. For imaging applications, the small-radius lens enlarges the numerical aperture of the optical fiber, allowing for imaging of near wavelength areas.

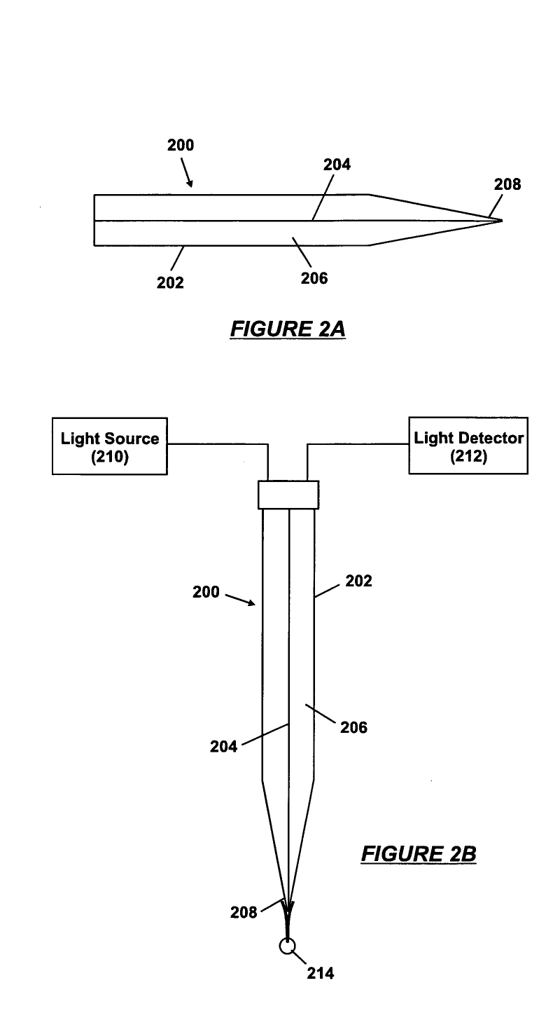

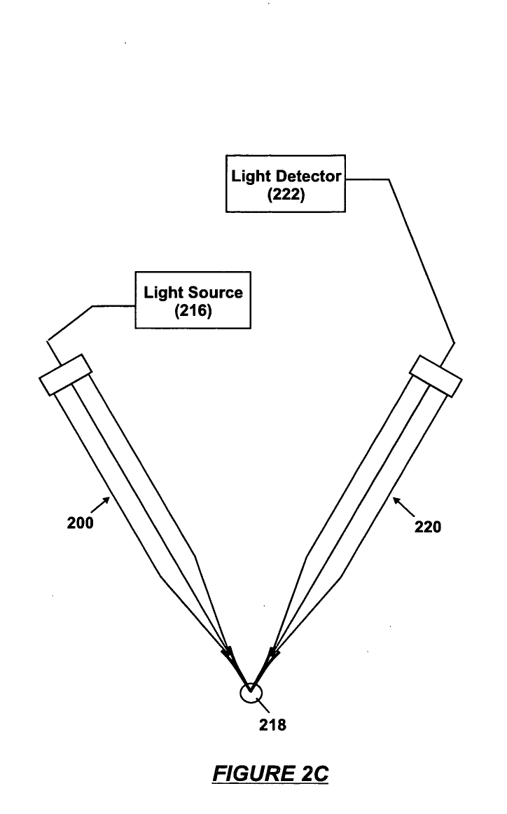

For illustration purposes, FIG. 2A shows a fiber-optic sensor probe 200 having a high numerical aperture according to one embodiment of the invention. The fiber-optic sensor probe 200 includes an optical fiber 202 having a core 204 surrounded by a cladding 206. The optical fiber 202 could be any single-mode fiber, including polarization-maintaining fiber (PM fiber), a multimode fiber, or other specialized fiber. A lens 208 is formed at a distal end of the optical fiber 202. The lens 208 has a small radius of curvature, e.g., in a range from 5 to 30 μm, preferably in a range from 5 to 20 μm. As an example, the lens 208 with a radius of curvature in a range from 5 to 30 μm can increase the numerical aperture of a Corning SMF-28® single-mode fiber from 0.11 up to 0.43, allowing for imaging of very small areas down to 1.8 times the wavelength of the light. The radius of curvature of the lens 208 can be made smaller to allow for imaging of areas smaller than 1.8 times the wavelength of the light; however, the beam emerging from the lens 208 will no longer be diffraction-limited.

The fiber-optic sensor probe 200 can be used alone in reflection mode or with another fiber-optic sensor probe or suitable detector in transmission mode. FIG. 2B shows the fiber-optic sensor probe 200 in reflection mode. In this mode, a light source 210 and a light detector 212 are coupled to one end of the fiber-optic sensor probe 202, remote from the lens 208. The optical fiber 202 is used to transmit light generated by the light source 210 to a surface 214 and to transmit light reflected from the surface 214 to the light detector 212. FIG. 2C shows the fiber-optic sensor probe 200 in transmission mode. In this mode, a light source 216 is coupled to one end of the fiber-optic sensor probe 200, remote from the lens 208, and the fiber-optic sensor probe 200 is used to transmit light from the light source 216 to a surface 218. Another fiber-optic sensor probe 220, similar to the fiber-optic sensor probe 200, is used to transmit light reflected from the surface 218 to a light detector 222.

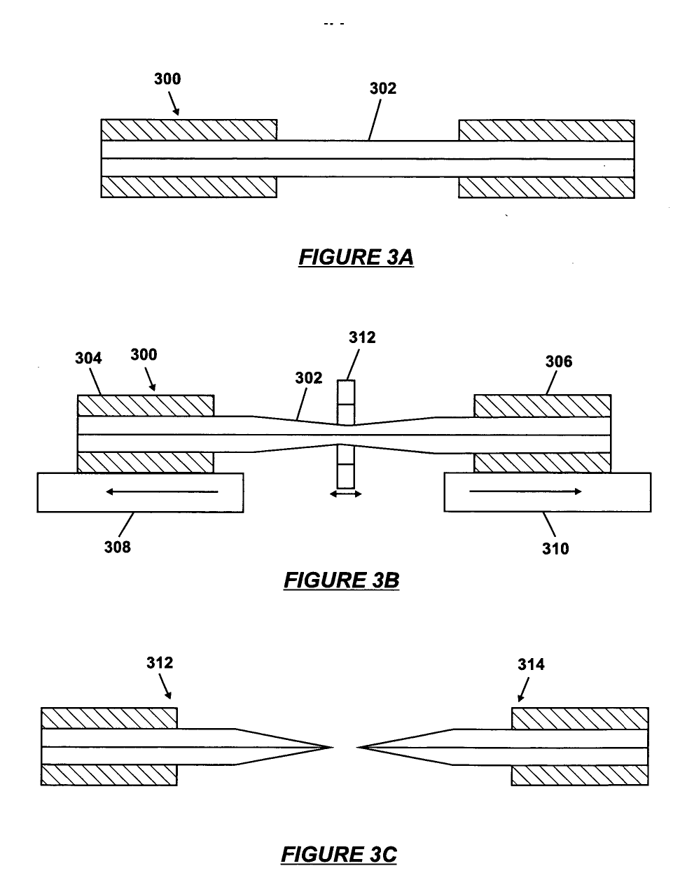

Referring now to FIG. 3A, a method of making a high numerical aperture fiber-optic sensor probe includes providing a fiber pigtail 300, i.e., a coated or buffered optical fiber. A middle region of the fiber pigtail 300 has been stripped to expose the underlying optical fiber 302. In FIG. 3B, the fiber pigtail sections 304, 306 flanking the exposed optical fiber 302 are mounted on linear stages 308, 310, respectively. A heating device 312, e.g., a filament, laser, torch, etc., is used to apply heat to the optical fiber 302 while the linear stages 308, 310 move in opposite directions. As the linear stages 308, 310 move in opposite directions, they apply tension along the axial axis of the optical fiber 302. The end result, as shown in FIG. 3C, is a taper-cut process that separates the optical fiber 302, forming two fiber-optic sensor probes 312, 314. This method is advantageous because two fiber-optic sensor probes can be simultaneously produced. Returning to FIG. 3B, preferably heat is slowly applied during the taper-cut process so that the core of the optical fiber 302 diffuses instead of curling to form a termination.

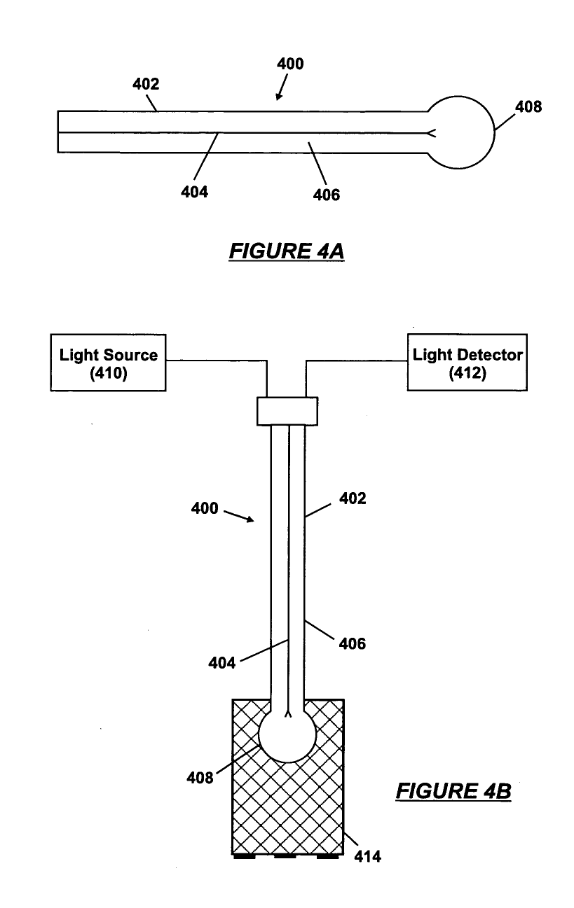

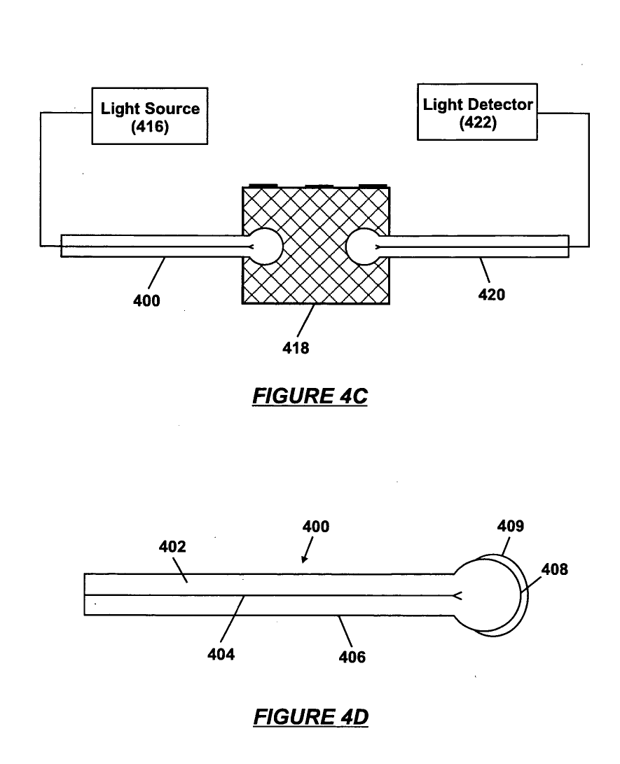

FIG. 4A shows a fiber-optic sensor probe 400 having a low numerical aperture according to another embodiment of the invention. The fiber-optic sensor probe 400 includes an optical fiber 402 having a core 404 surrounded by a cladding 406. The optical fiber 402 could be any single-mode fiber, including polarization-maintaining fiber (PM fiber), a multimode fiber, or other specialized fiber. A lens 408 is formed at a distal end of the optical fiber 402. The lens 408 has a large radius of curvature, e.g., in a range from 30 to 500 μm. For imaging applications, the lens 408 enlarges the numerical aperture of the optical fiber 402, allowing for imaging of large areas. The lens 408 creates a large surface area for interaction with the surrounding environment, enhancing the sensitivity of the fiber-optic sensor probe 400 as compared with traditional fiber-optic sensor probes. For sensing applications, the lens 408 may be embedded in a sensing material (419 in FIG. 4D) having optical properties, e.g., fluorescence, refractive index, or transmission at wavelength(s) to be monitored, that change upon interaction with the environment.

FIG. 4B shows the fiber-optic sensor probe 400 in reflection mode. In this mode, a light source 410 and a light detector 412 are coupled to one end of the fiber-optic sensor probe 402, remote from the lens 408. The optical fiber 402 is used to transmit light generated by the light source 410 to an environment 414, such as a reaction cell, and to transmit light reflected from the environment 414 to the light detector 412. FIG. 4C shows the fiber-optic sensor probe 400 in transmission mode. In this mode, a light source 416 is coupled to one end of the fiber-optic sensor probe 400, remote from the lens 408, and the fiber-optic sensor probe 400 is used to transmit light from the light source 416 to an environment 418. Another fiber-optic sensor probe 420, similar to the fiber-optic sensor probe 400, is used to transmit light reflected from the environment 418 to a light detector 422. In this example, the optical axes of the fiber-optic sensor probes 400, 420 are substantially aligned. However, this does not always have to be the case. Depending on the application, the optical axes of the fiber-optic sensor probes 400, 420 could be misaligned, e.g., in a manner similar to one shown for fiber-optic sensor probes 200, 220 in FIG. 2C.

Returning to FIG. 4A, the lens 408 can be designed to be collimating, focusing, or diverging, depending on the operation mode of the fiber-optic sensor probe 400 and the surrounding environment. For the reflection mode, a high return loss is desired. Therefore, a diverging lens is most efficient for this mode. The diverging lens can be used to tailor return loss to a desired value with or without use of reflective coating. In general, the shorter the lens, the higher the return loss. For the transmission mode, a low return loss is desired. The geometry of the lens 408 can be tailored to achieve a desired low return loss. In general, the longer the lens, the lower the return loss. An anti-reflective coating can also be applied on the lens 408 to further reduce the return loss. High coupling efficiency between the transmitting and receiving fiber-optic sensor probes is also desirable in the transmission mode. This can be achieved by using a collimating or focusing lens. For applications involving probing by focusing on a substrate, the lens 402 can be a focusing lens.

Table 1 shows properties of three fiber-optic sensor probes having lenses with radii of curvatures of 84 μm, 183 μm, and 210 μm, respectively. Each fiber-optic sensor probe was made from a Corning SMF-28′ single-mode fiber having a numerical aperture of 0.13. The measurements were made at 1550 nm. Table 1 shows mode field diameter at the apex of the lens (1/e²) for each fiber-optic sensor probe along with a calculated mode field radius (1/e²) in the associated optical fiber. The divergence measurements show that the beam quality (M²) is approximately 1, which means that the beam is single-mode diffraction-limited.

TABLE 1

| | Radius of | Mode field | Numerical | Mode field |
|---|---|---|---|---|
| Fiber-optic | curvature | diameter at lens | aperture of | radius in fiber |
| sensor probe | (μm) | apex (μm) | the lens | (μm) |
| A | 210 | 43 | 0.037 | 6.8 |
| B | 183 | 40 | 0.04 | 6.8 |
| C | 84 | 21 | 0.072 | 6.8 |

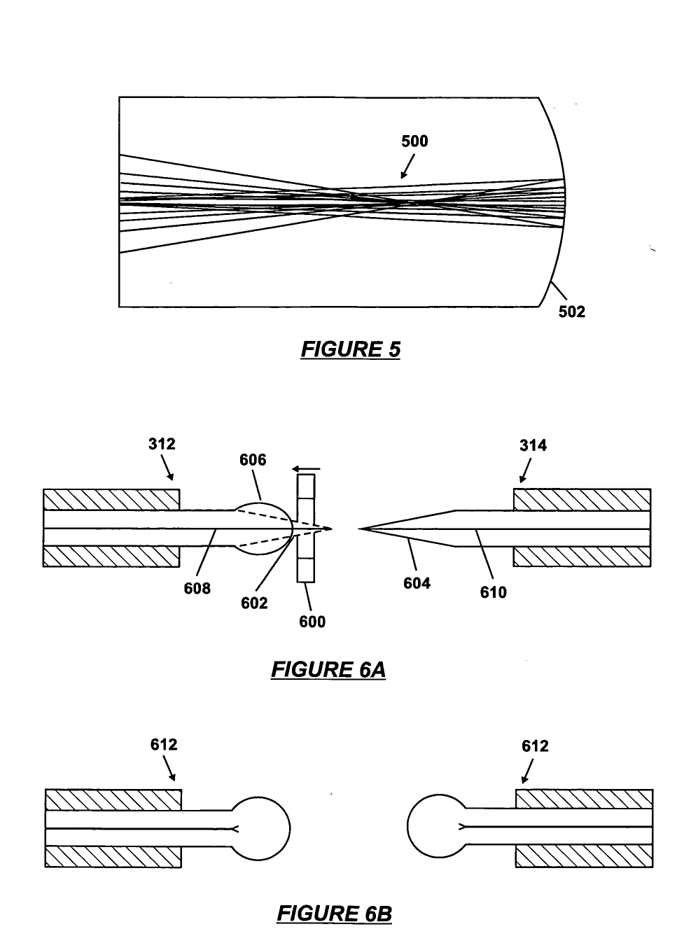

FIG. 5 shows a ray trace 500 of a fiber-optic sensor probe made from a Corning SMF-28® fiber terminated with a lens 502 having a radius of curvature of 210 μm. The ray trace shows that the lens 502 acts as a diverging lens. Although this affects use of the fiber-optic sensor probe in transmission mode, the fiber-optic sensor probe provides advantages in reflection mode and for imaging applications. In reflection mode, the lens can be made short to achieve a high return loss. It should be noted herein that the return loss achievable with the lensed fiber-optic sensor probe would generally be smaller than the return loss achievable with a fiber-optic sensor probe based on a cleaved or polished single-mode fiber. However, a lensed fiber-optic sensor probe still has the advantage of enhanced sensitivity because of the enlarged surface area provided by the lens for sampling.

For illustration purposes, the return loss for a Corning SMF-28® fiber terminated with a lens having a radius of curvature of 210 μm is about −26 dB (0.0022%), while the return loss for a cleaved or polished Corning SMF-28® fiber is 14.7 dB (3.3%). Thus, the return loss for the lensed fiber is decreased by about 10 fold in comparison to the return loss for the cleaved or polished fiber. On the other hand, the effective surface area for sampling for a cleaved or polished Corning SMF-28® fiber is 80 μm², while the effective surface area for sampling for a Corning SMF-28® fiber terminated with a lens having a radius of curvature of 210 μm is 3810 μm². Thus, the effective surface area for the lensed fiber is increased by about 50 fold in comparison to the effective surface area for a cleaved or polished fiber. The total gain in sensitivity by using a fiber-optic sensor probe with a radius of curvature of 210 μm is thus about 5 times compared to using a cleaved or polished single-mode fiber.

A method of making a low aperture fiber-optic sensor probe includes the steps illustrated in FIGS. 3A-3C. To make a lens having a large radius of curvature, an additional step is needed. FIG. 6A shows the low numerical aperture fiber-optic sensor probes 312, 314 formed by the method illustrated in FIGS. 3A-3C. The additional step for forming a large-radius lens involves using a heating device 600, preferably a filament, to apply heat to each of the taper-cut ends 602, 604 of the fiber-optic sensor probes (or optical fibers) 312, 314 so that surface tension pulls the taper-cut ends 602, 604 into spherical surfaces. FIG. 6A shows a spherical surface 606 being formed as heat is applied to the taper-cut end 602. The heat is applied slowly so that the cores 608, 610 diffuse instead of curling to form a termination. FIG. 6B shows the two low numerical aperture fiber-optic sensor probes 612, 614 formed after this additional step.

The fiber-optic sensor probes shown in Table 1 above were formed using the method just described. The power output of these fiber-optic sensor probes was measured to be 96.5%, indicating that the core of the optical fiber did not curl to form a termination while forming the large-radius lens.

The invention provides one or more advantages. The fiber-optic sensor probes can be used in reflection mode or transmission mode. The low numerical aperture fiber-optic sensor probe, i.e., the fiber-optic sensor probe having the large-radius lens, provides a large surface area for sampling, thereby enhancing the sensitivity of the fiber-optic sensor probe as compared with traditional fiber-optic sensor probes. The low numerical aperture fiber-optic sensor probe can also be used to image large areas. The high numerical aperture fiber-optic sensor probe can be used to image near wavelength areas. The method described above allows the fiber-optic sensor probes to be made at low cost.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of making a fiber-optic sensor probe, comprising:
stripping a region of a buffered fiber to expose an underlying optical fiber; and
separating the optical fiber to form two fiber-optic sensor probes by simultaneously applying heat and axial tension to the optical fiber.

2. The method of claim 1, wherein applying heat comprises allowing a core of the optical fiber at a point where the heat is applied to diffuse.

3. The method of claim 1, further comprising applying a reflective coating on a distal end of at least one of the fiber-optic sensor probes.

4. The method of claim 1, further comprising applying an anti-reflective coating on a distal end of at least one of the fiber-optic sensor probes.

5. The method of claim 1, wherein a distal end of each fiber-optic sensor probe comprises a convex surface having a radius of curvature in a range from 5 to 30 μm.

6. The method of claim 1, wherein a distal end of each fiber-optic sensor probe comprises a convex surface having a radius of curvature in a range from 5 to 20 μm.

7. A fiber-optic sensor probe, comprising:
an optical fiber having a distal end formed into a lens, the lens having a radius of curvature in a range from 5 to 30 μm.

8. A method of making a fiber-optic sensor probe, comprising:
stripping a region of a buffered fiber to expose an underlying optical fiber; and
separating the optical fiber to form two fiber-optic sensor probes by simultaneously applying heat and axial tension to the optical fiber; and
applying heat to a distal end of at least one of the fiber-optic sensor probes such that surface tension pulls the distal end into a spherical surface.

9. The method of claim 8, wherein applying heat comprises allowing a core of the optical fiber at a point where the heat is applied to diffuse.

10. The method of claim 8, further comprising applying a reflective coating on a distal end of at least one of the fiber-optic sensor probes.

11. The method of claim 8, further comprising applying an anti-reflective coating on a distal end of at least one of the fiber-optic sensor probes.

12. The method of claim 8, further comprising embedding the distal end of the fiber-optic sensor probe in a sensing material having at least one optical property that changes in response to a selected stimulus.

13. The method of claim 8, wherein a radius of curvature of the spherical surface is in a range from 30 to 500 μm.

14. A fiber-optic sensor probe, comprising:
an optical fiber having a distal end formed into a lens, the lens having a radius of curvature in a range from 30 to 500 μm.

15. The fiber-optic sensor probe of claim 14, wherein at least a portion of the lens is embedded in a sensing material having at least one optical property that changes in response to a selected stimulus.

16. The fiber-optic sensor probe of claim 14, wherein a reflective coating is formed on at least a portion of the lens.

17. The fiber-optic sensor probe of claim 14, wherein an anti-reflective coating is formed on at least a portion of the lens.
